(19) United States
(12) Patent Application Publication
(10) Pub. No.: US 2010/0238476 A1
(43) Pub. Date: Sep. 23, 2010

(54) FACSIMILE SYSTEM AND METHOD OF CONTROLLING SAME

(75) Inventor: Hiroyasu Morita, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/707,114

(22) Filed: Feb. 17, 2010

(30) Foreign Application Priority Data
Mar. 17, 2009 (JP) 2009-065217

(51) Int. Cl. G06F 15/00

(52) U.S. Cl. 358/1.13

(57) ABSTRACT

Disclosed is a facsimile system having first and second devices interconnected via a network. The first device allows a user to issue a facsimile transmission request, and the second device receives this facsimile transmission request and executes a facsimile transmission to a transmission destination. The first device has a determination unit for determining a caller telephone number based upon the user who issued the facsimile transmission request. The second device has a notification unit for notifying the transmission destination of the caller telephone number, which has been determined by the determination unit, when the facsimile transmission to the transmission destination is executed by the second device based upon the facsimile transmission request from the first device.

### BACKGROUND OF THE INVENTION

1. Field of the Invention

The present invention relates to a facsimile system having first and second devices interconnected via a network, wherein the first device is for allowing a user to issue a facsimile transmission request, and the second device receives this facsimile transmission request and executes a facsimile transmission to the transmission destination.

2. Description of the Related Art

With the progress that has been made in digitizing and networking information processing systems in recent years, a certain device in a facsimile system or the like that has read an image is now capable of using a plurality of network-connected image processing units to transmit this image to another device in the facsimile system and to cause this other device to execute image processing and to transmit the processed image. For example, there are cases where a document is read by a local device and another device executes image processing and transmits the processed image.

Such systems include a facsimile system in which an image that has been transmitted from a device not having a facsimile function is received and then transmitted by a device (a server) that does possess a facsimile function. In this case, use is made of a facsimile number that has been set in the server, wherein the facsimile number is one of which notification has been given by a caller telephone number notification service or by a facsimile procedure number.

However, in a system in which only notification of the facsimile number of the server is given at the time of a facsimile transmission, the true sender cannot be specified at the transmission destination. As a consequence, there may be instances where an incoming transmission from a sender is refused as an incoming transmission from an unfamiliar number.

In order to solve this problem, the specification of Japanese Patent Laid-Open No. 2005-244793 proposes a system in which a telephone number is assigned to a client device and notification of the telephone number assigned to the client device is given as the caller telephone number when there is a facsimile transmission from the server. Specifically, a table indicating correspondence between the client device and the telephone number that has been assigned thereto is provided in the server and notification of the telephone number that has been assigned to the client device is given as the caller telephone number when there is a facsimile transmission from the server.

This prior art is such that when there is a facsimile transmission from the server, notification is given not of the server line information but of the number that has been assigned to the client device. However, the number of which notification is given is strictly the number assigned to the client device and is not a number that has been assigned to the user or user group.

This means that it is required that the user always perform a transmission using a client device that has been decided. This is a problem in terms of convenience. That is, in a case where a user requests a facsimile transmission using a different client device, the transmission destination is notified of a different number.

In order to solve the above-mentioned problem, the present invention provides a facsimile system in which, when a facsimile transmission is performed via a second device in response to a facsimile transmission request from a first device, it is possible to notify of the caller telephone number that conforms to the user who issued the request.

### SUMMARY OF THE INVENTION

Accordingly, the present invention provides a facsimile system having first and second devices interconnected via a network, wherein the first device is for allowing a user to issue a facsimile transmission request, and the second device receives this facsimile transmission request and executes a facsimile transmission to a transmission destination, wherein the first device has a determination unit for determining a caller telephone number based upon the user who issued the facsimile transmission request, and the second device has a notification unit for notifying the transmission destination of the caller telephone number, which has been determined by the determination unit, when the facsimile transmission to the transmission destination is executed by the second device based upon the facsimile transmission request from the first device.

Further features of the present invention will become apparent from the following description of exemplary embodiments with reference to the attached drawings.

### BRIEF DESCRIPTION OF THE DRAWINGS

FIG. 1 is a diagram illustrating the general configuration of a digital multifunction peripheral (copier) to which an image processing apparatus according to the present invention is applied;

FIG. 2 is a diagram illustrating the configuration of a system in which an embodiment of the present invention is applied;

FIG. 3 is a diagram illustrating an example of a facsimile transmission setting screen in a first image processing apparatus;

FIG. 4 is a diagram illustrating an example of a facsimile transmission details setting screen in a first image processing apparatus;

FIG. 5 is a flowchart of processing executed in the first and second image processing apparatuses in a first embodiment;

FIG. 6 is a flowchart of processing executed in the first and second image processing apparatuses in a second embodiment;

FIG. 7 is a flowchart of processing executed in the first and second image processing apparatuses in a third embodiment; and

FIG. 8 is a flowchart of processing executed in the first and second image processing apparatuses in a fourth embodiment.

### DESCRIPTION OF THE EMBODIMENTS

### First Embodiment

A first embodiment of the present invention will now be described in detail with reference to the drawings.

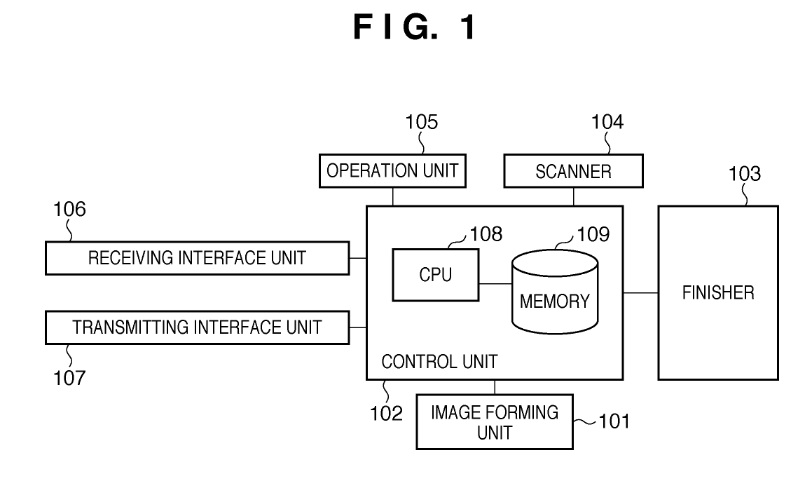

FIG. 1 is a block diagram illustrating the configuration of a digital multifunction peripheral (copier) to which an image processing apparatus according to the first embodiment is applied.

The digital copier includes an image forming unit 101 for forming an image on printing paper by a method such as electrophotography; a control unit 102 for controlling the digital copier; a finisher 103 for executing post-processing such as stapling; a scanner 104 for reading a document image; an operation unit 105 for inputting various data and commands; a plurality of receiving interface units 106 for receiving scan data and fax data, etc.; and a plurality of transmitting interface units 107 serving as transmitting means for transmitting scan data and fax data, etc.

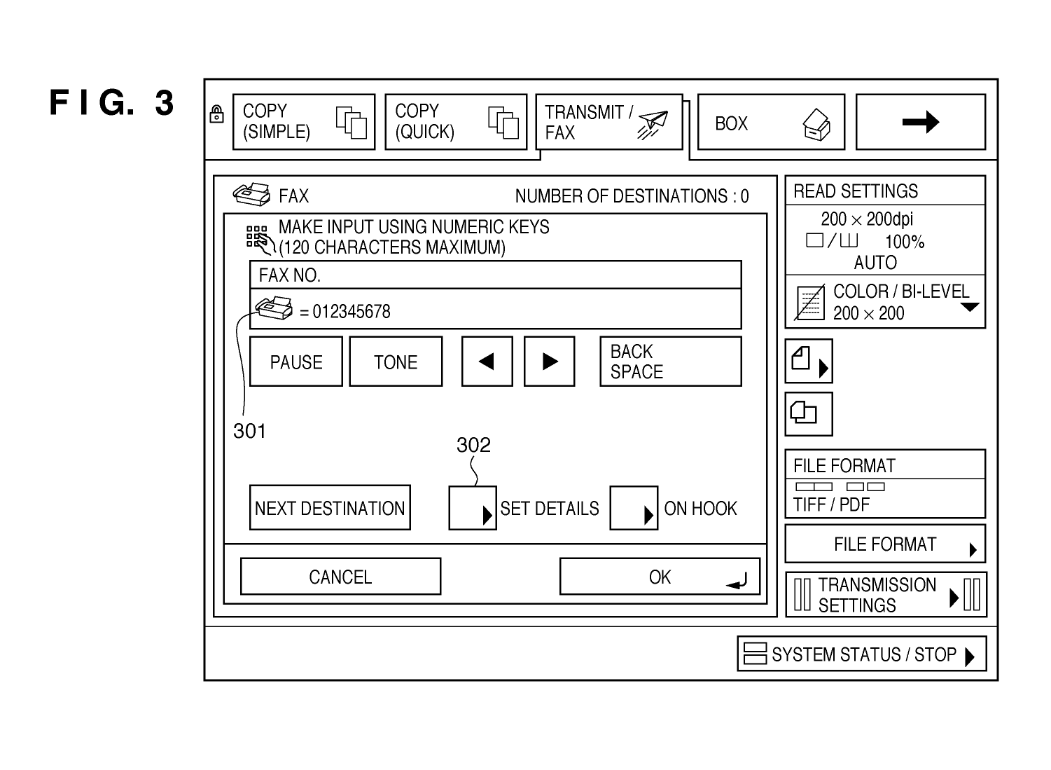

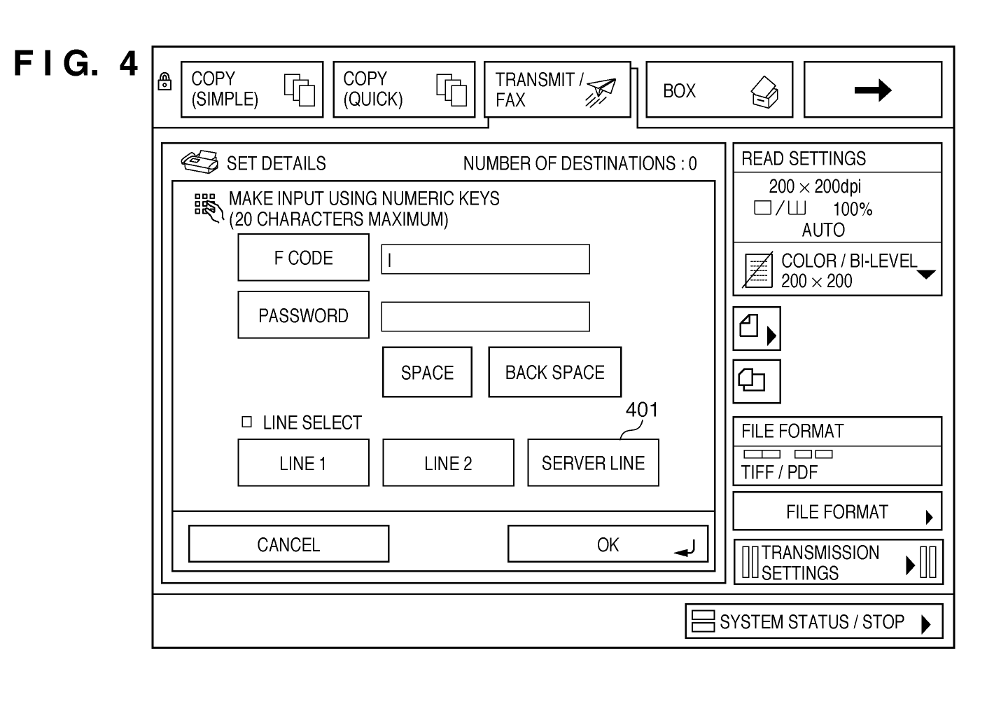

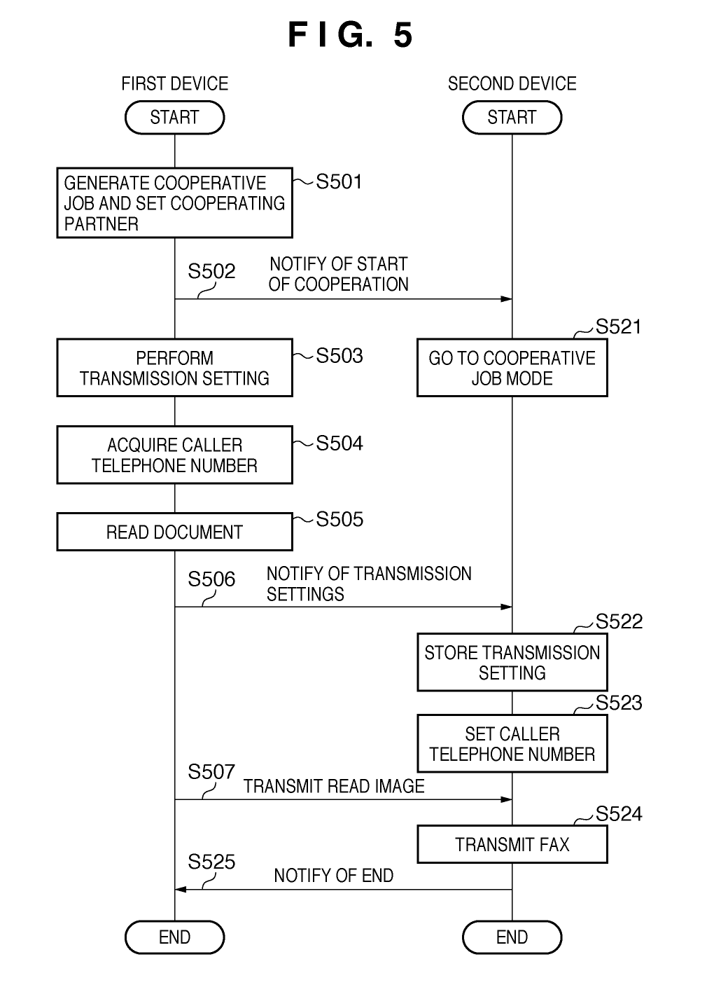

The image forming unit 101, finisher 103, scanner 104, operation unit 105, receiving interface units 106, which serve as receiving means, and transmitting interface unit 107 are connected to the control unit 102 by respective special-purpose interfaces. The control unit 102 primarily comprises a central processing unit (referred to as a “CPU” below)) 108 and a storage device (memory) 109. Control programs corresponding to respective flowcharts shown in FIGS. 5, 6, 7 and 8, described later, are stored in the storage device 109. Also stored in the storage device 109 are a control program for dialog boxes, shown in FIGS. 3 and 4, for configuring transmission, and content, etc., describing operating screen information.

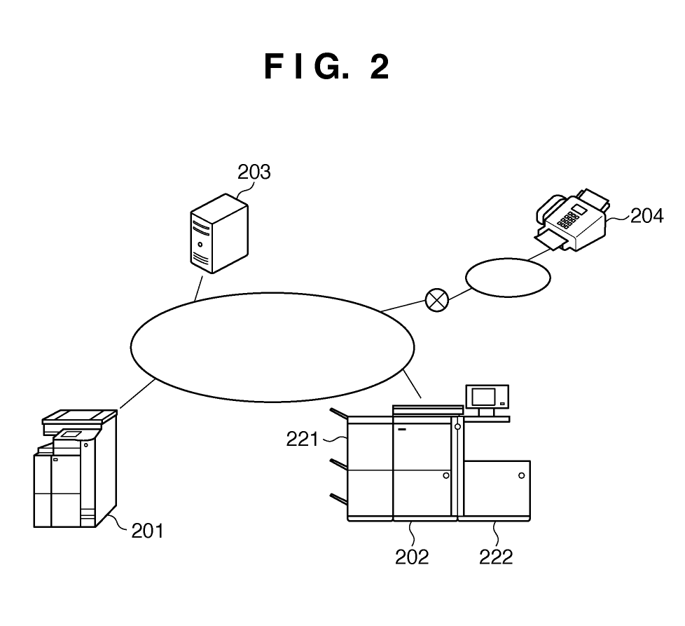

FIG. 2 is a diagram illustrating a facsimile system to which the first embodiment is applied.

As shown in FIG. 2, a first image processing apparatus 201 serving as a first device is used as a reading-side device when the user executes a cooperative job. The first image processing apparatus 201 is connected to a network (LAN) but is not connected to a public line (PSTN). In addition, it does not possess a facsimile communication function. A second image processing apparatus 202 serving as a second device is used as a cooperative-job transmitting-side device. The second image processing apparatus 202 is connected to both the network and to a public line. Further, the second image processing apparatus 202 has a facsimile communication function for executing a G3 facsimile function in accordance with, e.g., ITU-TT.30, via the public line.

An authentication server 203 includes receiving means for receiving user authentication information or notification of a transmission setting, caller telephone number retrieval means for retrieving a caller telephone number, server line retrieval means for retrieving the server line, and transmitting means for transmitting the retrieved caller telephone number or server line number. These means will be described later. The server line mentioned here indicates a line to which the second image processing apparatus 202 is connected, and the server line number indicates the telephone number that has been assigned to this line. However, it is assumed here that the second image processing apparatus 202 is capable of accepting calls based upon a plurality of telephone numbers in addition to the server line number and that it can originate a call using any of these telephone numbers as the originating source number. The authentication server 203 performs user authentication using the image processing apparatuses.

The first image processing apparatus 201, second image processing apparatus 202 and authentication server 203 are connected via the network. The second image processing apparatus 202 is connected to a facsimile apparatus 204 via the public line and performs facsimile communication with the facsimile apparatus 204 via the public line. It should be noted that although only one first image processing apparatus 201 for issuing a facsimile transmission request is shown in FIG. 2, it is possible for a plurality of these to be connected to the network.

FIG. 3 is a diagram illustrating an example of a transmission setting screen in the first image processing apparatus 201. Shown in FIG. 3 are a transmission-destination display area 301 for displaying the destination telephone number of a facsimile transmission, which is input by the operation unit 105. Also shown in FIG. 3 are a details setting button 302 which, by being pressed by the user, makes it possible to call a details setting screen for setting the details of a facsimile transmission.

FIG. 4 is a diagram illustrating an example of a facsimile transmission details setting screen in the first image processing apparatus 201. Line selection buttons 401 for designating the line to be used at the time of a transmission are displayed on the screen in FIG. 4. The user is capable of designating any line from among lines 1 and 2 assigned to the user and a server line assigned to the second image processing apparatus 202. FIG. 5 is a flowchart of processing executed in the first and second image processing apparatuses in the first embodiment.

At step S501, on the basis of an input from the operation unit 105, the CPU 108 of the control unit in the first image processing apparatus 201 instructs the generation of a cooperative job for performing a facsimile transmission by the second image processing apparatus 202 and sets the second image processing apparatus 202 as the cooperating partner. At step S502, the CPU 108 of the control unit in the first image processing apparatus 201 notifies the second image processing apparatus 202, which has been set as the cooperating partner, of the start of the cooperative job.

At step S521, when notification of start of the cooperative job given at step S502 is received by the receiving interface unit 106 of the second image processing apparatus 202, the CPU 108 shifts to the cooperative job mode and prepares for receipt of the cooperative job from the first image processing apparatus 201. At step S503, the CPU 108 of the first image processing apparatus 201 performs a transmission setting necessary for the cooperative job based upon an input from the operation unit 105. Accordingly, using the screen shown in FIG. 4, the user selects the line that the user desires to use.

The first image processing apparatus 201 has determination means. At step S504, the determination means acquires the caller telephone number, which corresponds to the line selected in accordance with the selection operation performed by the user, from among caller telephone numbers that have been stored in the storage device 109 and thus determines the caller telephone number. At step S505, the CPU 108 of the first image processing apparatus 201 reads in the original document of the cooperative job from the scanner 104.

At step S506, after the document is read in, the CPU 108 of the first image processing apparatus 201 transmits notification of the transmission setting, which was made at step S503, to the second image processing apparatus 202 via the transmitting interface unit 107. The transmission setting includes the transmission destination number of the cooperative job and the caller telephone number acquired at step S504. At step S522, the CPU 108 of the second image processing apparatus 202 stores the transmission setting, of which it was notified by the first image processing apparatus 201 at step S506, in the storage device 109 of the second image processing apparatus 202.

At step S523, the CPU 108 of the second image processing apparatus 202 sets the caller telephone number contained in the received transmission setting, and of which notification was obtained from the first image processing apparatus 201, as the caller telephone number for when it is utilized in execution of the cooperative job by the second image processing apparatus 202. At step S507, the CPU 108 of the first image processing apparatus 201 sends the second image processing apparatus 202 the read image of the original document of the cooperative job read at step S505.

At step S524, the receiving interface unit 106 of the second image processing apparatus 202 receives the transmission of the original document image of the cooperative job sent from the first image processing apparatus 201 at step S507. The CPU 108 of the second image processing apparatus 202 then performs a facsimile transmission to the transmission destination of the cooperative job contained in the transmission setting stored at step S522. Here the caller telephone number corresponds to the line selected by the user at step S503. That is, in a case where the user has selected line 1 or line 2, even though the apparatus that originated the call is the second image processing apparatus 202, the telephone number of which notification is given by a caller telephone notification service is not one that has been assigned to this apparatus but is the telephone number that has been assigned to the user. Further, the telephone number that has been assigned to the user is set to a TSI signal, which is the procedure signal of facsimile communication, and in this way notification is given to the transmission destination. At step S525, after the facsimile transmission at step S524 is completed, the CPU 108 of the second image processing apparatus 202 notifies the first image processing apparatus 201 of end of the cooperative job and quits processing. The CPU 108 of the first image processing apparatus 201 receives the end notification from the second image processing apparatus 202 at step S525 and quits processing.

### Second Embodiment

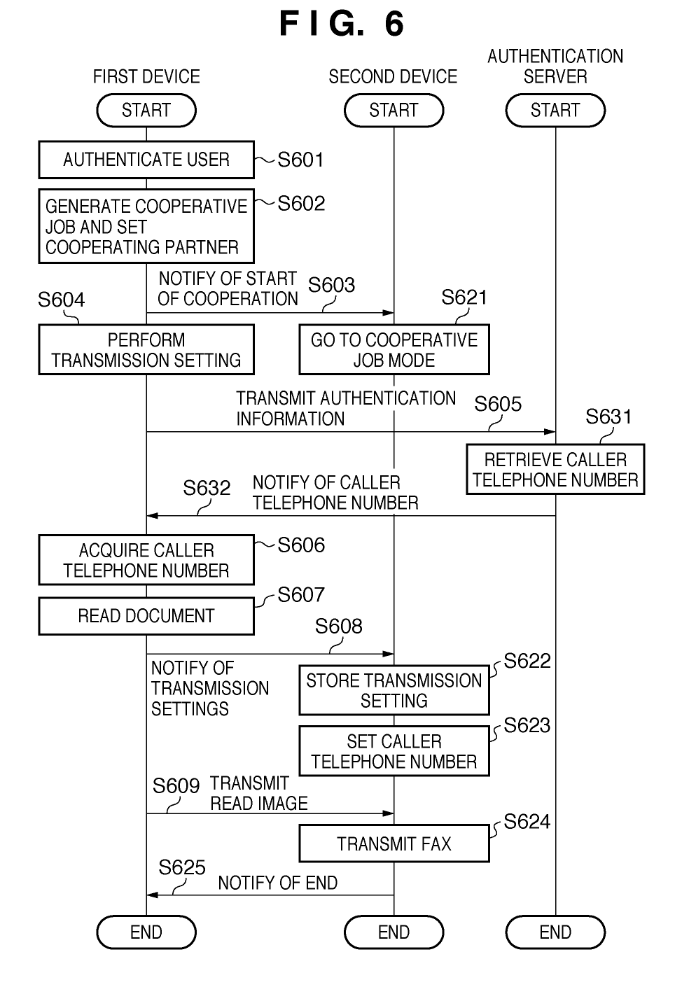

In the first embodiment, the caller telephone number used in a cooperative job utilizes one that has been registered in the first image processing apparatus 201. In a second embodiment, means are provided for authenticating the user who uses the image processing apparatus. If a caller telephone number based upon user authentication information is used as the caller telephone number of a cooperative job, then user convenience can be enhanced further. FIG. 6 is a flowchart of processing executed in the first and second image processing apparatuses in the second embodiment.

At step S601, the CPU 108 of the first image processing apparatus 201 executes authentication of the user of the image processing apparatus in accordance with an input from the operation unit 105. That is, the ID, etc., of the user or of a group to which the user belongs is input and the user is specified based upon this input. At step S602, the CPU 108 instructs generation of a cooperative job for performing a facsimile transmission by the second image processing apparatus 202 and sets the second image processing apparatus 202 as the cooperating partner.

At step S603, the CPU 108 notifies the second image processing apparatus 202, which has been set as the cooperating partner, of the start of the cooperative job. At step S621, when notification of start of the cooperative job given at step S603 is received by the receiving interface unit 106 of the second image processing apparatus 202, the CPU 108 shifts to the cooperative job mode and prepares for receipt of the cooperative job from the first image processing apparatus 201.

At step S604, the CPU 108 of the first image processing apparatus 201 performs a transmission setting necessary for the cooperative job in accordance with an input from the operation unit 105. At step S605, the CPU 108 of the first image processing apparatus 201 transmits the authentication information of step S601 to the authentication server 203 from the transmitting interface unit 107.

At step S631, on the basis of the user authentication information of which notification was given by the first image processing apparatus 201 at step S605, the authentication server 203 performs retrieval of the caller telephone number based upon user-related information that has been stored in the authentication server 203. At step S632, the authentication server 203 sends the first image processing apparatus 201 the caller telephone number obtained at step S631.

At step S606, the CPU 108 of the first image processing apparatus 201 acquires the caller telephone number of which it was notified by the authentication server 203 at step S632. At step S607, the CPU 108 of the first image processing apparatus 201 reads in the original document of the cooperative job from the scanner 104.

At step S608, after the original document is read in at step S607, the CPU 108 of the first image processing apparatus 201 transmits notification of the transmission setting, which was made at step S604, to the second image processing apparatus 202. The transmission setting includes the transmission destination number of the cooperative job and the user-related caller telephone number acquired at step S606. At step S622, the CPU 108 of the second image processing apparatus 202 stores the transmission setting, of which it was notified by the first image processing apparatus 201 at step S608, in the storage device 109 of the second image processing apparatus 202.

At step S623, the CPU 108 of the second image processing apparatus 202 sets the caller telephone number contained in the received transmission setting, and of which notification was obtained from the first image processing apparatus 201, as the caller telephone number for when it is utilized in execution of the cooperative job by the second image processing apparatus 202. At step S609, the CPU 108 of the first image processing apparatus 201 sends the second image processing apparatus 202 the read image of the original document of the cooperative job read at step S607.

At step S624, the receiving interface unit 106 of the second image processing apparatus 202 receives the transmission of the original document image of the cooperative job sent from the first image processing apparatus 201 at step S609. The CPU 108 of the second image processing apparatus 202 then performs a facsimile transmission to the transmission destination of the cooperative job contained in the transmission setting stored at step S622. Here the transmission destination is notified of the caller telephone number of the user in a manner similar to that of the first embodiment. At step S625, after the facsimile transmission at step S624 is completed, the CPU 108 of the second image processing apparatus 202 notifies the first image processing apparatus 201 of end of the cooperative job and quits processing.

The CPU 108 of the first image processing apparatus 201 receives the end notification from the second image processing apparatus 202 at step S625 and quits processing. It should be noted that this embodiment has been described in a form in which the user-related caller telephone number has been saved in the authentication server connected to the first image processing apparatus 201 via the network. However, this may just as well be implemented within the first image processing apparatus 201 or second image processing apparatus 202. Further, the caller telephone number of the authenticated user is transmitted to the first image processing apparatus 201 from the authentication server at step S632. Instead of such an arrangement, however, it may be so arranged that the caller telephone number of the authenticated user is transmitted to the second image processing apparatus 202 and the second image processing apparatus 202 performs the transmission using the caller telephone number.

### Third Embodiment

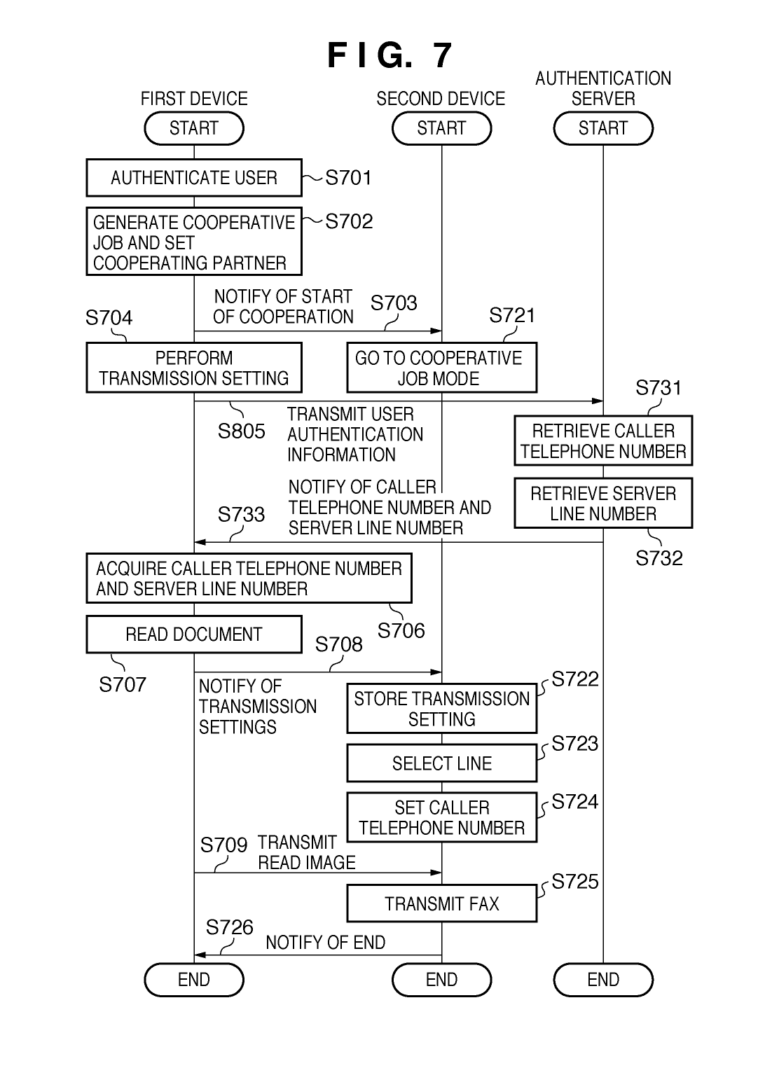

In the second embodiment, a caller telephone number acquired in association with user authentication information is utilized as the caller telephone number of a cooperative job. In a third embodiment, this is supplemented by acquiring line information of the server (a second image processing apparatus) utilized when a cooperative job is executed in association with user authentication, and using this information at the time of the transmission. If this arrangement is adopted, user convenience can be enhanced further. FIG. 7 is a flowchart of processing executed in the first and second image processing apparatuses in the third embodiment.

At step S701, the CPU 108 of the first image processing apparatus 201 executes authentication of the user of the image processing apparatus in accordance with an input from the operation unit 105 in a manner similar to that described above. At step S702, the CPU 108 of the first image processing apparatus 201 instructs generation of a cooperative job for performing a facsimile transmission by the second image processing apparatus 202 and sets the second image processing apparatus 202 as the cooperating partner.

At step S703, the CPU 108 of the first image processing apparatus 201 notifies the second image processing apparatus 202, which has been set as the cooperating partner, of the start of the cooperative job. At step S721, when notification of start of the cooperative job given at step S703 is received by the receiving interface unit 106 of the second image processing apparatus 202, the CPU 108 shifts to the cooperative job mode and prepares for receipt of the cooperative job from the first image processing apparatus 201.

At step S704, the CPU 108 of the first image processing apparatus 201 performs a transmission setting necessary for the cooperative job in accordance with an input from the operation unit 105. At step S705, the CPU 108 of the first image processing apparatus 201 transmits the authentication information acquired at step S701 to the authentication server 203 from the transmitting interface unit 107.

At step S731, on the basis of the user authentication information of which notification was given by the first image processing apparatus 201 at step S705, the authentication server 203 performs retrieval of the caller telephone number based upon user-related information, the number being retrieved from among caller telephone numbers stored by the authentication server 203. At step S732, the authentication server 203 performs retrieval of the server line number based upon the user-related information. It should be noted that instead of performing this retrieval, it may be so arranged that the server line number that has been registered in the second image processing apparatus 202 is used as is.

At step S733, the authentication server 203 sends the first image processing apparatus 201 the caller telephone number and server line number obtained at steps S731 and S732, respectively. At step S706, the CPU 108 of the first image processing apparatus 201 acquires the caller telephone number of which it was notified by the authentication server 203 at step S733.

At step S707, the CPU 108 of the first image processing apparatus 201 acquires the server line number and reads in the original document of the cooperative job from the scanner 104. At step S708, after the original document is read in at step S707, the CPU 108 of the first image processing apparatus 201 transmits notification of the transmission setting, which was made at step S704, to the second image processing apparatus 202. The transmission setting includes the transmission destination number of the cooperative job and, in addition, the user-related caller telephone number and server line number acquired at step S706.

At step S722, the CPU 108 of the second image processing apparatus 202 stores the transmission setting, of which it was notified by the first image processing apparatus 201 at step S708, in the storage device 109 of the second image processing apparatus 202. At step S723, the CPU 108 of the second image processing apparatus 202 sets the server line number, of which it was notified by the first image processing apparatus 201, as the line number utilized when the second image processing apparatus 202 executes the cooperative job. The line number set here becomes the caller telephone number of which notification is given to the transmission destination by the caller telephone number notification service.

At step S724, the CPU 108 of the second image processing apparatus 202 sets the caller telephone number, of which it has been similarly notified, as the caller telephone number. The caller telephone number set here becomes the caller telephone number set in the TSI signal. At step S709, the CPU 108 of the first image processing apparatus 201 sends the second image processing apparatus 202 the read image of the original document of the cooperative job read at step S707.

At step S725, the CPU 108 of the second image processing apparatus 202 receives the transmission of the original document image of the cooperative job sent from the first image processing apparatus 201 at step S709 and performs a facsimile transmission to the transmission destination of the cooperative job contained in the transmission setting stored at step S722. Here the transmission destination is notified of the caller telephone number that has been set as described above. At step S726, after the facsimile transmission is completed, the CPU 108 of the second image processing apparatus 202 notifies the first image processing apparatus 201 of end of the cooperative job and quits processing.

The first image processing apparatus 201 receives the end notification from the second image processing apparatus 202 at step S726 and quits processing. It should be noted that the third embodiment has been described in a form in which, in addition to the user-related caller telephone number, a server line number utilized at the time of transmission of a cooperative job is acquired and utilized. Moreover, if a user-related cover page is stored in the authentication server, this is acquired based upon authentication information and it is transmitted together with the read document at the time of transmission of the cooperative job, then a further improvement in user convenience will be achieved.

### Fourth Embodiment

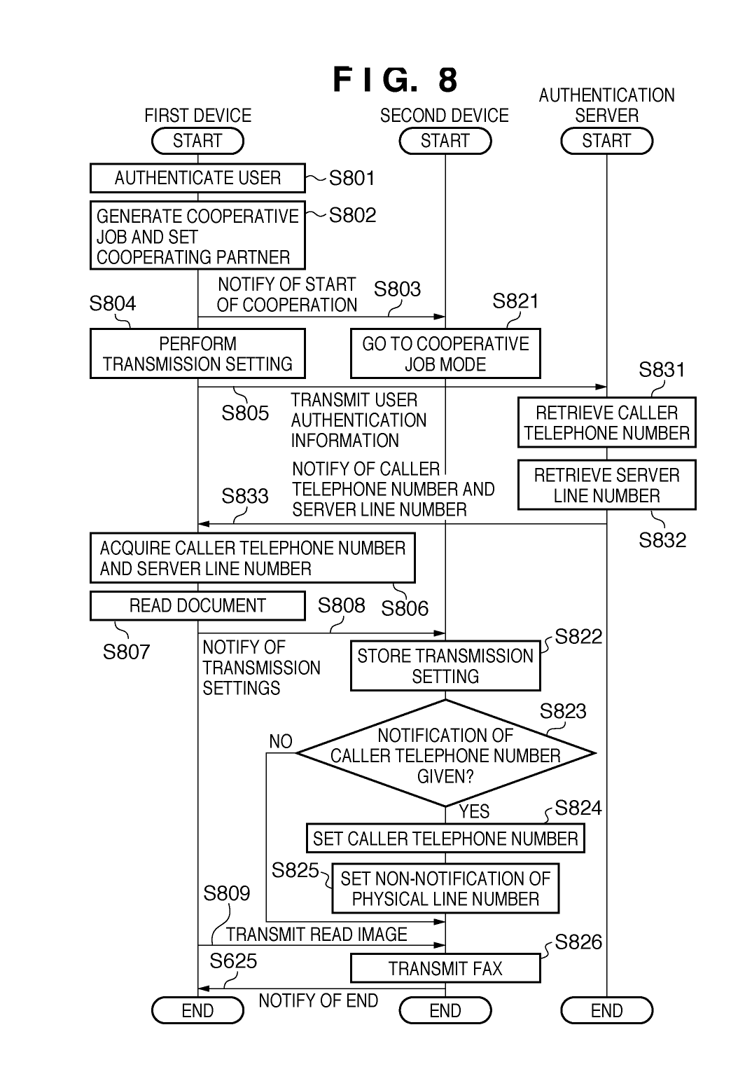

In the first to third embodiments, a caller telephone number acquired in association with user authentication information is utilized as the caller telephone number of a cooperative job. In a fourth embodiment, this is supplemented by so arranging it that in a case where a number other than a server line number is used as the caller telephone number of a cooperative job, notification of the physical line number information of the server is not given. This further enhances user convenience. FIG. 8 is a flowchart of processing executed in the first and second image processing apparatuses in the fourth embodiment.

At step S801, the CPU 108 of the first image processing apparatus 201 executes authentication of the user of the image processing apparatus in accordance with an input from the operation unit 105 in a manner similar to that described above. At step S802, the CPU 108 of the first image processing apparatus 201 instructs generation of a cooperative job for performing a facsimile transmission by the second image processing apparatus 202 and sets the second image processing apparatus 202 as the cooperating partner.

At step S803, the CPU 108 of the first image processing apparatus 201 notifies the second image processing apparatus 202, which has been set as the cooperating partner, of the start of the cooperative job. At step S821, when notification of start of the cooperative job given at step S803 is received by the receiving interface unit 106 of the second image processing apparatus 202, the CPU 108 shifts to the cooperative job mode and prepares for receipt of the cooperative job from the first image processing apparatus 201.

At step S804, the CPU 108 of the first image processing apparatus 201 performs a transmission setting necessary for the cooperative job in accordance with an input from the operation unit 105. At step S805, the CPU 108 of the first image processing apparatus 201 transmits the authentication information acquired at step S801 to the authentication server 203 from the transmitting interface unit 107.

At step S831, on the basis of the user authentication information of which notification was given by the first image processing apparatus 201 at step S805, the authentication server 203 performs retrieval of the caller telephone number based upon user-related information, the number being retrieved from among caller telephone numbers stored by the authentication server 203. At step S832, the authentication server 203 performs retrieval of the server line number based upon the user-related information. It should be noted that instead of performing this retrieval, it may be so arranged that the server line number that has been registered in the second image processing apparatus 202 is used as is.

At step S833, the authentication server 203 sends the first image processing apparatus 201 the caller telephone number and server line number obtained at steps S831 and S832, respectively. At step S806, the CPU 108 of the first image processing apparatus 201 acquires the caller telephone number of which it was notified by the authentication server 203 at step S833.

At step S807, the CPU 108 of the first image processing apparatus 201 reads in the original document of the cooperative job from the scanner 104. At step S808, after the original document is read in at step S807, the CPU 108 of the first image processing apparatus 201 transmits notification of the transmission setting, which was made at step S7804, to the second image processing apparatus 202. The transmission setting includes the transmission destination number of the cooperative job and, in addition, the user-related caller telephone number acquired at step S806.

At step S822, the CPU 108 of the second image processing apparatus 202 stores the transmission setting, of which it was notified by the first image processing apparatus 201 at step S808, in the storage device 109 of the second image processing apparatus 202. At step S823, the CPU 108 of the second image processing apparatus 202 determines whether a caller telephone number is included in the transmission setting of which notification was given by the first image processing apparatus 201 and which was stored at step S822. If a “NO” decision is rendered at step S823, then control proceeds to step S826 without a caller telephone number being set.

If a “YES” decision is rendered at S823 (i.e., if a caller telephone number is included in the transmission setting), then, at step S824, the CPU 108 of the second image processing apparatus 202 sets the transmission setting, of which it has been notified by the first image processing apparatus 201, as the caller telephone number for when the cooperative job is executed. At step S825, the CPU 108 of the second image processing apparatus 202 sets the physical line information of the server, which was received at step S808, to non-notification when the cooperative job is executed.

At step S809, the CPU 108 of the first image processing apparatus 201 sends the second image processing apparatus 202 the read image of the original document of the cooperative job read at step S807. At step S826, the receiving interface unit 106 of the second image processing apparatus 202 receives the transmission of the original document image of the cooperative job sent from the first image processing apparatus 201 at step S809. The CPU 108 then performs a facsimile transmission to the transmission destination of the cooperative job contained in the transmission setting stored at step S822. Here the user-related caller telephone number is set in the TSI signal and in this way the transmission destination is notified of the this information. However, the call is originated with non-notification by the caller telephone number notification service.

At step S827, after the facsimile transmission of step S826 is completed, the CPU 108 of the second image processing apparatus 202 notifies the first image processing apparatus 201 of end of the cooperative job and quits processing. The first image processing apparatus 201 receives the end notification from the second image processing apparatus 202 at step S726 and quits processing.

In accordance with the embodiments described above, the destination of a facsimile transmission can be notified not of a caller telephone number that has been assigned to the apparatus proper operated by the user but of a caller telephone number that has been assigned to the user himself (or to the group to which the user belongs). Further, the user can request a facsimile transmission from various devices on a network and notification of the caller telephone number that has been assigned to this user can be given at such time.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g. computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-065217, filed Mar. 17, 2009, which is hereby incorporated by reference herein in its entirety.

What is claimed is:

1. A facsimile system having first and second devices interconnected via a network, wherein said first device is for allowing a user to issue a facsimile transmission request, and said second device receives this facsimile transmission request and executes a facsimile transmission to a transmission destination;
said first device having a determination unit for determining a caller telephone number based upon the user who issued the facsimile transmission request; and
said second device having a notification unit for notifying the transmission destination of the caller telephone number, which has been determined by said determination unit, when the facsimile transmission to the transmission destination is executed by said second device based upon the facsimile transmission request from said first device.

2. The system according to claim 1, wherein said first device further has an authentication unit for authenticating the user, and said determination unit determines a caller telephone number that corresponds to the user authenticated by said authentication unit.

3. The system according to claim 1, wherein said determination unit determines a caller telephone number in accordance with a selection operation performed by the user of said first device.

4. The system according to claim 1, wherein said communication unit notifies the transmission destination of the caller telephone number determined by said determination unit and of a caller telephone number that has been assigned to said second device.

5. The system according to claim 1, wherein said communication unit notifies the transmission destination of the caller telephone number, which has been determined by said determination unit, upon setting this caller telephone number in a facsimile-communication procedure signal.

6. A method of controlling a facsimile system having first and second devices interconnected via a network, wherein the first device is for allowing a user to issue a facsimile transmission request, and the second device receives this facsimile transmission request and executes a facsimile transmission to a transmission destination, said method comprising:
a step of a caller telephone number being determined by the first device based upon the user who issued the facsimile transmission request; and
a step of the transmission destination being notified of the determined caller telephone number by the second device when the facsimile transmission to the transmission destination is executed by the second device based upon the facsimile transmission request.
